(19) United States
(12) Patent Application Publication
(10) Pub. No.: US 2002/0152307 A1
(43) Pub. Date: Oct. 17, 2002

(54) Methods, systems and computer program products for distribution of requests based on application layer information

(76) Inventors: Ronald Patrick Doyle, Raleigh, NC (US); John R. Hind, Raleigh, NC (US)

Correspondence Address: MYERS BIGEL SIBLEY & SAJOVEC, PO BOX 37428, RALEIGH, NC, 27627, US

(21) Appl. No.: 09/833,925

(22) Filed: Apr. 12, 2001

(51) Int. Cl. G06F 9/00; G06F 15/173

(52) U.S. Cl. 709/225; 709/105

(57) ABSTRACT

Methods, systems and computer program products are discussed for distributing workload between a plurality of servers. A plurality of requests are received over a first connection. The plurality of requests are parsed to determine application layer information associated with each of the plurality of requests. Destination servers are selected for each of the plurality of requests based on the determined application layer information. The plurality of requests are distributed to the selected destination servers over a plurality of second connections associated with each of the destination servers.

### BACKGROUND OF THE INVENTION

The present invention relates to network communications and more particularly to workload distribution between a plurality of servers.

Scalability and load balancing in network servers are issues which have received considerable attention in light of the expansion of the Internet. For example, it may be desirable to have multiple servers servicing customers. The workload of such servers may be balanced by providing a single network visible Internet Protocol (IP) address which is mapped to multiple servers.

Such a mapping process may be achieved by, for example, network address translation (NAT) facilities, dispatcher systems and Dynamic Name Server/WorkLoad Management (DNS/WLM) systems from International Business Machines Corporation (IBM), Armonk, N.Y. These various mechanisms for allowing multiple servers to share a single IP address are illustrated in FIGS. 1 through 3.

FIG. 1 illustrates a conventional network address translation system as described above. In the system of FIG. 1, a client 10 communicates over a network 12 to a network address translation (NAT) system 14. The network address translation system receives the communications from the client 10 and converts the communications from the addressing scheme of the network 12 to the addressing scheme of the network 12′ and sends the messages to the servers 16. A server 16 may be selected from multiple servers 16 at connect time and may be on any host, one or more hops away. All inbound and outbound traffic flows through the NAT system 14.

FIG. 2 illustrates a conventional DNS/WLM system as described above. The server 16 is selected at name resolution time when the client 10 resolves the name for the destination server from the DNS/WLM system 17 which is connected to the servers 16 through the coupling facility (CF) 19. The DNS/WLM system 17 of FIG. 2 relies on the client 10 adhering to a “zero time to live” lifetime for IP addresses such that IP addresses are not cached by the client. Packets exiting the server 16 are sent over network 12′. It will be understood that although the DNS/WML system 17 is shown in the path of the client 10 and the server 16, the prior art is not limited to this configuration.

FIG. 3 illustrates a conventional dispatcher system. As seen in FIG. 3, the client 10 communicates over the network 12 with a dispatcher system 18 to establish a connection. The dispatcher routes inbound packets to the servers 16 and outbound packets are sent over network 12′ but may flow over any available path to the client 10. The servers 16 are typically on a directly connected network to the dispatcher 18 and a server 16 is selected at connect time.

Such a dispatcher system is illustrated by the Interactive Network Dispatcher function of the IBM 2216 and AIX platforms. In these systems, the same IP address that the Network Dispatcher node 18 advertises to the routing network 12 is activated on server nodes 16 as loopback addresses. The node performing the distribution function connects to the endpoint stack via a single hop connection because normal routing protocols typically cannot be used to get a connection request from the endpoint to the distributing node if the endpoint uses the same IP address as the distributing node advertises. Network Dispatcher uses an application on the server to query a workload management function (such as WLM of System/390), and collects this information at intervals, e.g. 30 seconds or so. Applications running on the Network Dispatcher node 18 can also issue “null” queries to selected application server instances as a means of determining server instance health. In addition to the above described systems, Cisco Systems offers a Multi-Node Load Balancing function on certain of its routers that performs the distribution function. Such operations appear similar to those of the IBM 2216.

In addition to the system described above, AceDirector from Alteon provides a virtual IP address and performs network address translation to a real address of a selected server application. AceDirector appears to observe connection request turnaround times and rejection as a mechanism for determining server load capabilities.

Another mechanism for allowing multiple servers to share a single IP address is known as proxying, where the client establishes an initial connection to a proxy application and the proxy application forms a second connection with the proper server after obtaining enough information from the client to select a server. Such mechanism may have the advantage that the selection and communication with the selected server by the proxy may be transparent to the client. However, both inbound and outbound communications must, typically, traverse a protocol stack twice to be routed by the proxy application. First, the communications traverse the protocol stack to the proxy application and again traverse the protocol stack when routed by the proxy application. Such traversals of the protocol stack may consume significant processing resources at the server executing the proxy application.

Other mechanisms include Virtual Telecommunications Access Method (VTAM) multi-node persistent session support. VTAM multi-node persistent session support allows for recovering a System Network Architecture (SNA) session state on another VTAM when an application fails and is restarted. However, typically, a client must re-authenticate to the applications or other system using multi-node persistent sessions. Furthermore, such a movement from a first VTAM to a second VTAM typically only occurs after a failure.

VTAM also supports CLSDEST PASS, which causes one SNA session with the client to be terminated and another initiated without disrupting the application using the sessions. Such a movement from one session to another, however, typically requires client involvement.

### SUMMARY OF THE INVENTION

Embodiments of the present invention provide methods, systems and computer program products for distributing workload between a plurality of servers. A plurality of requests may be received over a first connection. The plurality of requests may be parsed to determine application layer information associated with each of the plurality of requests. Destination servers may be selected for each of the plurality of requests based on the determined application layer information. The plurality of requests may be distributed to the selected destination servers over a plurality of second connections associated with each of the destination servers.

In particular embodiments of the present invention, the first connection may be a Hypertext Transport Protocol (HTTP) 1.1 connection and the plurality of requests may be HTTP requests. The application layer information may be layer 7 information and above and may be a type of request, a client identification, an individual user identification, and/or a cookie.

In some embodiments of the present invention, a starting point and an ending point for each of the plurality of requests within the first connection may be determined. Application layer information within each of the plurality of requests may be identified. It is determined if the identified application layer information is relevant application layer information. A destination server is selected based on the existence or nonexistence of relevant application layer information. If relevant application layer information exists one of a subset of the destination servers is selected. If relevant application layer information does not exist a destination server other than a destination server in the subset of the destination servers is selected. In further embodiments of the present invention, the subset of destination servers includes at least one server which receives requests having an indication of high priority, the indication of high priority may be determined based on the existence or nonexistence of relevant application layer information. The load of each server in a subset of servers may be determined and the destination server may be selected from the subset of destination servers based on the determined load.

In still further embodiments of the present invention, it is determined if a connection to a selected destination server exists. If the connection already exists, the request is distributed over the established connection. If the connection does not already exist, the connection may be established and the request may be distributed over the newly established connection.

In further embodiments of the present invention, receiving, parsing, selecting and distributing may be carried out by an application executing on a data processing system. The plurality of requests may be tracked along with a plurality of corresponding responses to the plurality of requests. The plurality of requests and corresponding responses may be routed using network address translation at a routing layer of a communication protocol stack.

### BRIEF DESCRIPTION OF THE DRAWINGS

FIG. 1 is a block diagram of a conventional network address translation (NAT) system;

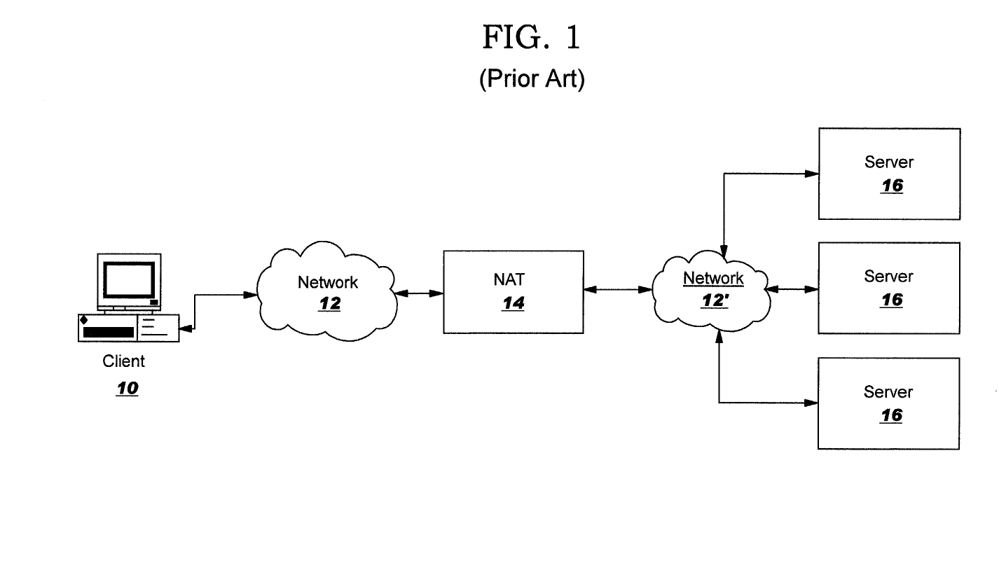

FIG. 2 is a block diagram of a conventional DNS/WLM system;

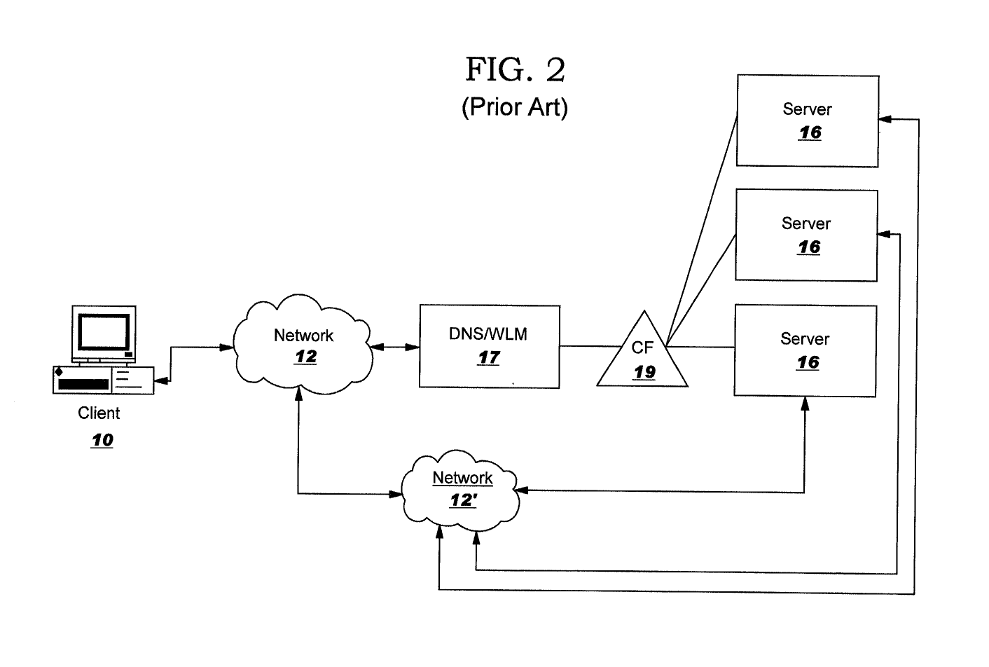

FIG. 3 is a block diagram of a conventional dispatcher system;

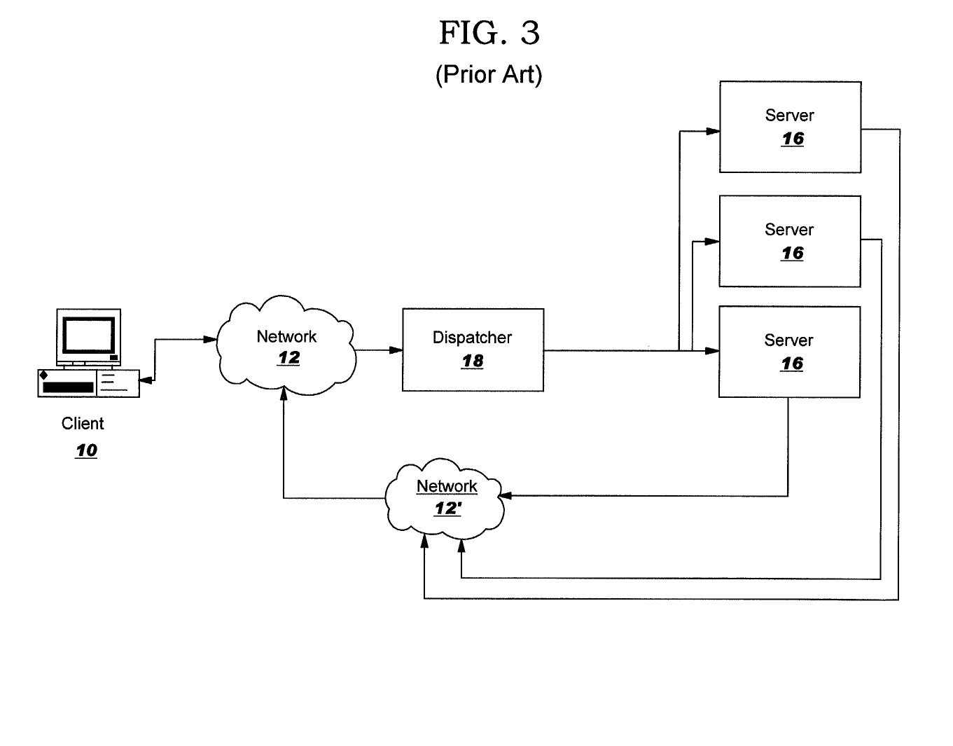

FIG. 4 is a block diagram illustrating embodiments of the present invention;

FIG. 5 is a flowchart illustrating operations of a workload distributor according to embodiments of the present invention;

FIG. 6 is a flowchart illustrating operations of a workload distributor according to other embodiments of the present invention;

FIG. 7 is a flowchart illustrating operations of a workload distributor according to further embodiments of the present invention; and

FIG. 8 is a flowchart illustrating operations of a workload distributor according to still further embodiments of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention can take the form of an entirely hardware embodiment, an entirely software (including firmware, resident software, micro-code, etc.) embodiment, or an embodiment containing both software and hardware aspects. Furthermore, the present invention can take the form of a computer program product on a computer-usable or computer-readable storage medium having computer-usable or computer-readable program code embodied in the medium for use by or in connection with an instruction execution system. In the context of this document, a computer-usable or computer-readable medium can be any structure that can contain, store, communicate, propagate, or transport the program for use by or in connection with the instruction execution system, apparatus, or device.

The computer-usable or computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a removable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

As described in detail below, the present invention may be embodied as systems, methods, or computer program products which provide for workload distribution of individual requests received over a single connection between a plurality of servers. As used herein, the term “server” is used generally to refer to an entity capable of executing an application which may respond to requests and which may be a target for distribution of requests by the workload distributor. Thus, examples of “servers” may include a data processing system or operating system executing on a data processing system if multiple operating system images may execute on a single data processing system.

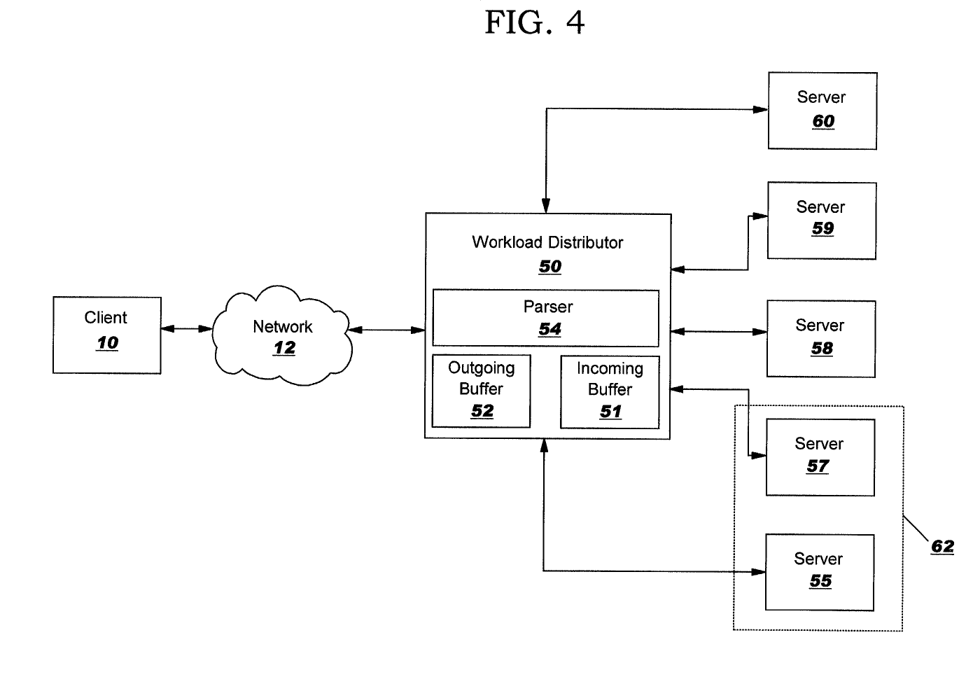

Various embodiments of the present invention will now be described with reference to FIGS. 4 through 8. A system incorporating embodiments of the present invention is illustrated in FIG. 4. As seen in FIG. 4, a workload distributor 50 communicates with a network 12 so as to receive a first connection request from a client 10 for a connection to applications executing on a cluster of target servers. A plurality of individual requests may be received over the first connection established between the network 12 and the workload distributor 50. In other words, the first connection typically does not close after the first request received over the connection is processed, thus many requests may be received at the workload distributor 50 over the first connection. The first connection may be, for example, a Hypertext Transport Protocol (HTTP) 1.1 connection. Since the workload distributor 50 receives many requests over the first connection it typically has the capability to recognize and store state information with respect to the individual requests, such as the starting point and ending point of each request, for example, an HTTP request, received over the first connection.

The workload distributor 50 distributes the individual requests received over the first connection over a plurality of second connections to the target servers which may be executing the requested application. For example, target servers 55, 57, 58, 59 and 60 may each be executing an instance of a common application. The plurality of second connections may be established by the workload distributor 50. Alternatively, the plurality of second connections may be pre-established. Other servers may be included in the cluster which are executing other applications, however, for clarity of illustration, these servers are not shown in FIG. 4. Furthermore, the target servers 55, 57, 58, 59, and 60 may be executing instances of other applications. Workload distribution may also be carried out according to the teachings of the present invention for these other applications, however, for purposes of clarity the examples of the present invention are described with reference to one application.

The workload distributor may receive a request over the first connection and store the request in an incoming buffer 51. The incoming buffer 51 may be used to store the request for a short period of time while the request is parsed by the parser 54 to determine application layer information, such as information available above the TCP/IP layers (e.g. “layer 7” information), associated with the request. The determined application layer information may also be stored in the incoming buffer 51. The parsing of the request may be accomplished in a number of ways. For example, a cookie sent in the received request may be examined to determine the user or class of user sending the request. This information about the user or class of user may be used to route different users or classes of users to a certain server or sets of servers. Alternatively, a requested Uniform Resource Locator (URL) in the received request may be determined. This URL or a prefix of the URL may be used to route the request to certain servers or sets of servers. For example, if the requested URL is or begins with /www.ibm.com/news it may be sent to a particular server or set of servers reserved for this URL. On the other hand, if the requested URL is or begins with /www.ibm.com/deals it may be sent to a different server or set of severs reserved for this URL, i.e. servers that are guaranteed to have this particular set of web pages.

The workload distributor 50 may also convert the request from the addressing scheme of the network 12 to the addressing scheme of a destination server while the request is stored in the incoming buffer 51. The workload distributor may select a destination server for the individual requests received over the first connection from the plurality of target servers 55, 57, 58, 59 and 60 based on the existence of relevant application layer information in the request. For example, a subset of available servers may be set aside for individual requests that contain relevant application layer information.

The relevant application layer information may be defined by the user and may include a type of request, a client identification, an individual user identification, a cookie, or the like. The presence of the relevant application layer information in the request may be considered an indication of high priority. For example, a subset of servers 62 may be established including target servers 55 and 57 of the total potential target servers 55, 57, 58, 59 and 60 for an application. The subset 62 may be associated with relevant application layer information (indications of high priority), such as the identity of the client requesting the connection, such that individual requests containing the relevant application layer information are preferentially distributed by the workload distributor 50 to the target servers 55 and 57 in the subset of servers 62. Thus, the subset of servers is essentially a group of reserved back-end servers used to satisfy important requests. Any application layer information in the individual requests which may provide the basis for distinguishing between requests may be utilized in determining if an individual request should be preferentially routed to a subset of servers. It will be understood by those having skill in the art that the tasks performed by the workload distributor 50, for example, receiving, parsing, distributing and the like, may be carried out by an application executing on data processing system.

It will be understood that the workload distributor 50 may track the individual requests and corresponding responses to the individual requests. The workload distributor 50 may store the corresponding responses to the individual requests in an outgoing buffer 52 while it performs network address translation (NAT) or the like, on the response. For example, the workload distributor may receive the corresponding response from one of the servers and convert the corresponding response from the addressing scheme of the server to the addressing scheme of the network 12. The corresponding responses may be distributed from the outgoing buffer 52 to the client 10 over the network 12. The network address translation (NAT) of both the incoming request and corresponding response may be performed at a routing layer of a communication protocol stack or at an application layer.

It will be understood that the network address translation performed by the workload distributor has the capability to perform functions not attributed to a conventional network address translation device. The workload distributor may also perform some session control translation, i.e. conceal the fact that the requests are being routed to different back-end servers from the client. For example, many requests are received over a single connection, i.e. during a single session, and each of these requests may be routed to different servers based on the existence or nonexistence of relevant application layer information in the request. The workload distributor has the capability to isolate the client from the fact that the requests are being routed to different back-end servers. In other words, as far as the client is concerned all of the requests are being routed to a single server over a single second connection. Session control translation is typically required to achieve this transparency. For example, session control translation may be used to cover the manipulation of a TCP/IP window so that the client does not detect the transitions between back-end servers between requests. As will be appreciated by those of skill in the art, the particular session control translation required will be architecture/system dependent. Accordingly, embodiments of the present invention may include translation of differing session control parameters depending on the particular implementation of the workload distributor and back-end servers.

In certain embodiments of the present invention, the workload distributor 50 may determine the loads of target servers 55 and 57 in the subset of servers 62 and distribute the request based on the determined loads. For example, the request may be distributed to the target server in the subset of servers 62 with the lightest load. The servers in the subset of servers 62 may have superior operational characteristics which may be used to provide a higher quality of service (QoS) to a select group of requests that contain relevant application layer information as discussed above. These superior operational characteristics may include processing capabilities such as content location, processing speed, available memory or other performance criteria, communication capabilities, such as total available bandwidth, connection speed, connection type or the like, security issues or even ownership issues such as ownership and/or control of the data processing systems.

By directing individual requests received over the first connection that contain relevant application layer information to a subset of target servers 62, differentiation between individual requests may be provided, i.e. those requests having an indication of high priority may be serviced first. Thus, for example, different service levels may be provided by evaluating the application layer information contained in the requests and providing requests to subsets of available servers based on the whether the application layer information is relevant application layer information.

In one example, if the servers are application service providers, then different levels of performance could be sold to different customers. These different performance levels may be associated with different subsets of application servers. The application layer information of individual requests received over the first connection for connections to an application server could be evaluated to determine the performance level that a customer corresponding to the requesting client paid for and the second connection assigned to the subset of application servers associated with that performance level. Similarly, in an e-commerce system, types of transactions could be segregated such that requests associated with purchases were handled by higher performance machines than those associated with browsing of an on-line catalog.

Furthermore, different subsets of servers may be utilized based on the type of data associated with the request. For example, if a request was for a connection to provide streaming audio or video, a different subset of servers may be used than if the request was for a connection to download of a data file. Additionally, when the individual requests originate from different types of devices, the type of device could be used to select a subset of servers. For example, a subset of processors with low processing performance could be assigned to wireless devices which have lower bandwidth communication capabilities. Requests from desktop systems with higher bandwidth communication capabilities could result in the selection of a subset of servers with higher processing performance. As is seen from the above discussion, embodiments of the present invention may be used in a variety of situations and/or environments with subsets of servers selected in a different manner based on the particular situation and/or environment.

It will be understood that the workload distributor 50 may select an application based on the application layer information contained in the request. For example, different clusters of servers may be running different applications. Alternatively, servers within the same cluster may be running instances of multiple applications. The workload distributor may examine the application layer information and select a destination server based on whether it is running the particular application determined from the application layer information contained in the request. It will also be understood that each of the clusters of servers may also contain subsets of servers used to satisfy important requests. Thus, if the request is determined to have an indication of high priority, the workload distributor may route the request to a subset of servers running the requested application that are used to satisfy important requests.

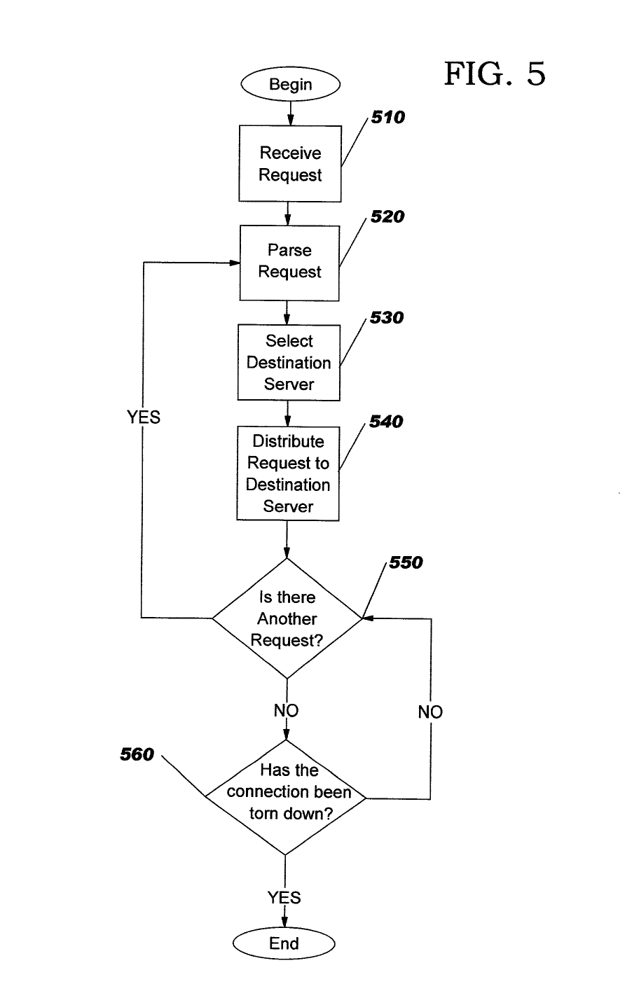

Embodiments of the present invention will now be described in detail below with reference to FIGS. 5, 6, 7 and 8 which are flowchart illustrations of operations carried out by a workload distributor according to embodiments of the present invention. As shown in FIG. 5 the workload distributor receives a request for a connection to an application executing on a target server (block 510). It will be understood that the request is received over a first connection, for example, an HTTP 1.1 connection, that does not close after the request is processed, i.e. the session is not torn down after the request is processed. Thus, a plurality of requests may be received over a single first connection.

The request may be stored in an incoming buffer and parsed to determine application layer information, such as information available above the TCP/IP layers(e.g. “layer 7” information), in the request (block 520). The determined application layer information may also be stored in the incoming buffer. As discussed above, relevant application layer information may be predefined. Relevant application layer information may include any application layer information in the individual requests which may provide the basis for distinguishing between requests. For example, relevant application layer information may include a type of request, a client identification, an individual user identification, a cookie or the like.

A destination server for the request may be selected based upon the determined application layer information contained in the request (block 530). For example, if the relevant application layer information is present in the request, the request may be given an indication of high priority. Thus, the workload distributor may select a destination server that is in the subset of destination servers (reserved back-end servers) as discussed above that may be used to satisfy important requests.

The request may be distributed to the selected destination server over a second connection associated with the selected destination server (block 540). It will be understood that this second connection may be established by the workload distributor. Alternatively, the second connection may be pre-established. The workload distributor may track the request and a corresponding response to the request. The response may be stored in an outgoing buffer while the workload distributor translates the network address from the addressing scheme of the destination server to the addressing scheme of a network. Once translated, the response may be distributed over the network to a client. As discussed above, routing of the plurality of requests and corresponding responses may be accomplished using network address translation and session control translation at a routing layer of a communication protocol stack or at an application layer.

It is determined if another request has been received over the first connection (block 550). If another request has been received operations return to block 520 and the process repeats until no more requests have been received or it is determined that the first connection has been torn down (block 560). If it is determined that another request has not been received (block 550), operations remain at block 550 until a request is received or it is determined that the first connection has been torn down (block 560).

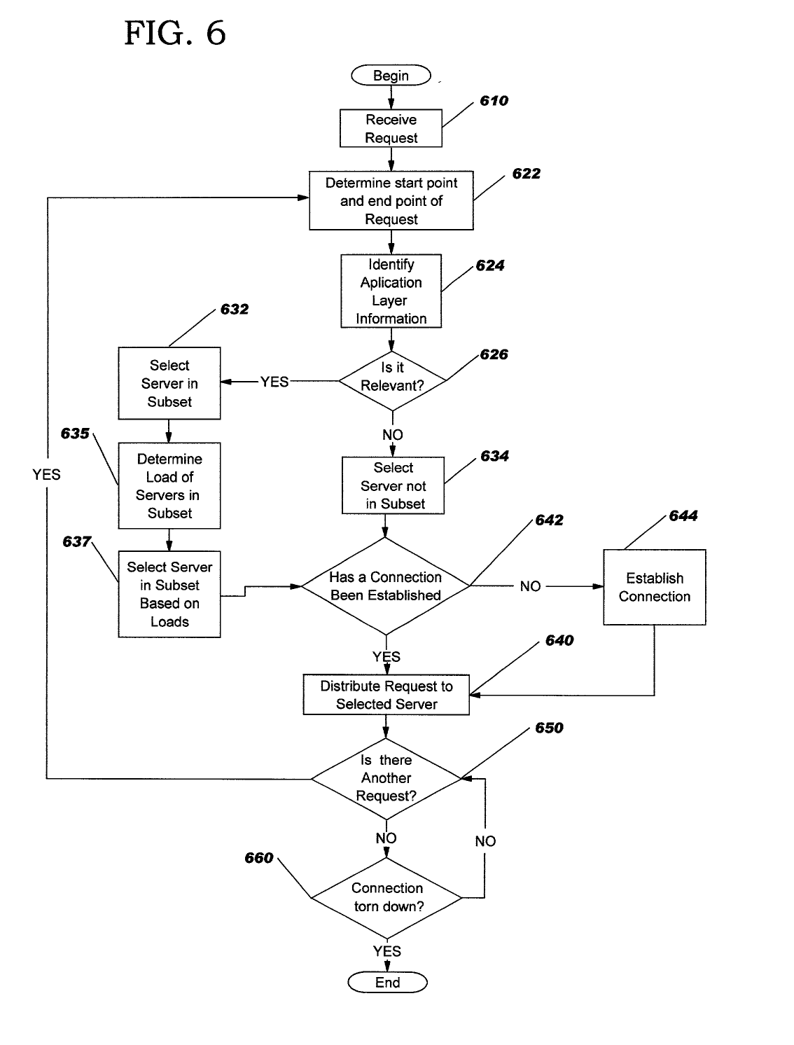

Now referring to FIG. 6, a flowchart illustrating operations carried out by a workload distributor according to other embodiments of the present invention will be described. The workload distributor receives a request for a connection to an application executing on a target server (block 610). As discussed above with respect to FIG. 5, the request is received over a first connection, for example, an HTTP 1.1 connection, that does not close after the request is processed. Thus, a plurality of requests may be received over a single first connection. Since the workload distributor may receive a plurality of requests over a single connection, the workload distributor may determine a starting point and ending point of each request received over the first connection (block 622).

The request may be stored in an incoming buffer and application layer information, such as information available above the TCP/IP layers (e.g. “layer 7” information), in the request may be identified (block 624). The determined application layer information may also be stored in the incoming buffer. It is determined if the identified application layer information is relevant (block 626). As discussed above, relevant application layer information may be predefined. Relevant application layer information may include any application layer information contained in the individual requests which may provide the basis for distinguishing between requests. For example, relevant application layer information may include a type of request, a client identification, an individual user identification, a cookie or the like.

If the identified application layer information is determined to be relevant (block 626), a destination server is chosen from a subset of destination severs. The subset of destination servers may include at least one server which is set aside to receive requests that contain the relevant application layer information, i.e. an indication of high priority. If it is determined that a request contains an indication of high priority, the workload distributor may determine a load associated with each of the destination servers in the subset of destination servers (block 635). The workload distributor may select the destination server in the subset of the destination servers based on the determined loads of the subset of destination servers (block 637). For example, the workload distributor may choose the destination server with the lightest load to thereby provide the highest possible Quality of Service (QoS). If it is determined that the identified application layer information is not relevant (block 626), the workload distributor may select a destination server that is not in the subset of destination servers (block 634).

It is determined if a connection to the selected destination server is established (block 642). If it is determined that the connection to the selected destination server is not established, the workload distributor may establish the connection to the destination server (block 644) and distribute the request over the newly established connection to the selected destination server (block 640). If it is determined that the connection to the selected destination server is already established (block 642), the request is distributed to the selected destination server over the previously established connection (block 640).

It is determined if another request has been received over the first connection (block 650). If it is determined that another request has been received operations return to block 622 and the process repeats until no more requests have been received or it is determined that the first connection has been torn down (block 660). If it is determined that another request has not been received (block 650), operations remain at block 650 until a request is received or it is determined that the first connection has been torn down (block 660). It will be understood by those having skill in the art that the tasks carried out by the workload distributor may be carried out by an application executing on a data processing system.

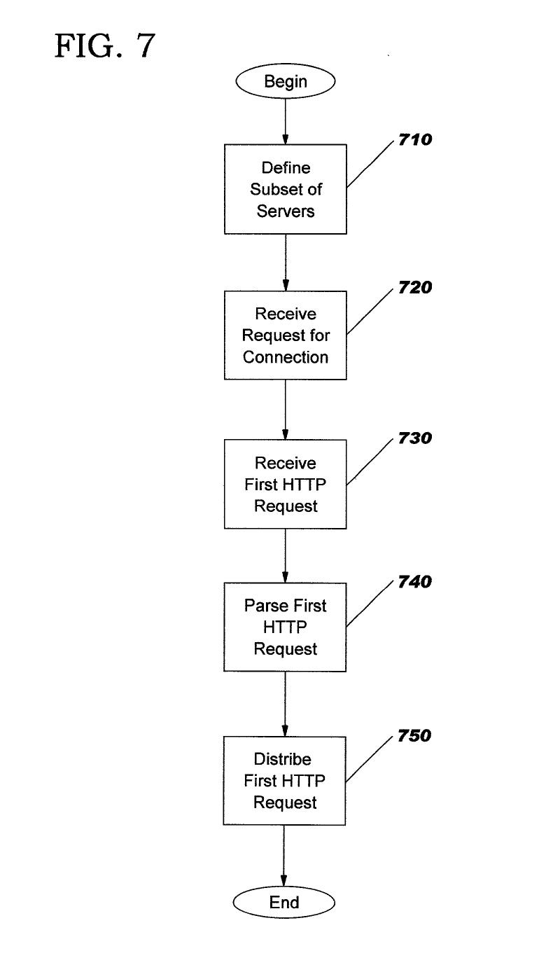

Now referring to FIG. 7, a flowchart illustrating operations carried out by a workload distributor according to further embodiments of the present invention will be described. A subset of a plurality of servers that are designated to receive HTTP requests having an indication of high priority may be defined (block 710). Each of the plurality of servers may be executing an instance of a requested application. As discussed above, the servers in the subset of servers may have superior operational characteristics which may enable the servers in the subset of servers to provide a relatively higher quality of service (QoS) to a select group of users. These operational characteristics may include content location, processing speed, available memory or other performance criteria, communication capabilities, such as total available bandwidth, connection speed, connection type or the like, security issues or even ownership issues such as ownership and/or control of the data processing systems. A request for an HTTP 1.1 connection from the network to the workload distributor is received (block 720) and may be stored in an incoming buffer. An HTTP 1.1 connection is the type of connection that does not close after a single request is processed, i.e. the connection is not torn down after the first request is processed. Thus, a plurality of HTTP requests may be received over a single HTTP 1.1 connection. An HTTP request for an application is received over the HTTP 1.1 connection (block 730). The HTTP request may be, for example, a GET request, a HEAD request, a PUT request, a POST request or the like. The workload distributor of the present invention may identify a starting point and ending point for each HTTP request received over the HTTP 1.1 connection. This state information may also be stored in the incoming buffer.

The HTTP request may be parsed to determine if the HTTP request contains any relevant application layer information, such as information available above the TCP/IP layers (e.g. “layer 7” information) (block 740). The presence of relevant application layer information may be an indication of high priority as discussed above. Thus, requests with an indication of high priority may be routed to a subset of reserved servers used to satisfy important requests.

The HTTP request is distributed to one of the plurality of servers executing an instance of the requested application (block 750). For example, if the HTTP request contains an indication of high priority the request may be distributed to one of the servers in the subset of servers. Alternatively, if the HTTP request does not contain an indication of high priority the request may be distributed to one of the servers not in the subset of servers.

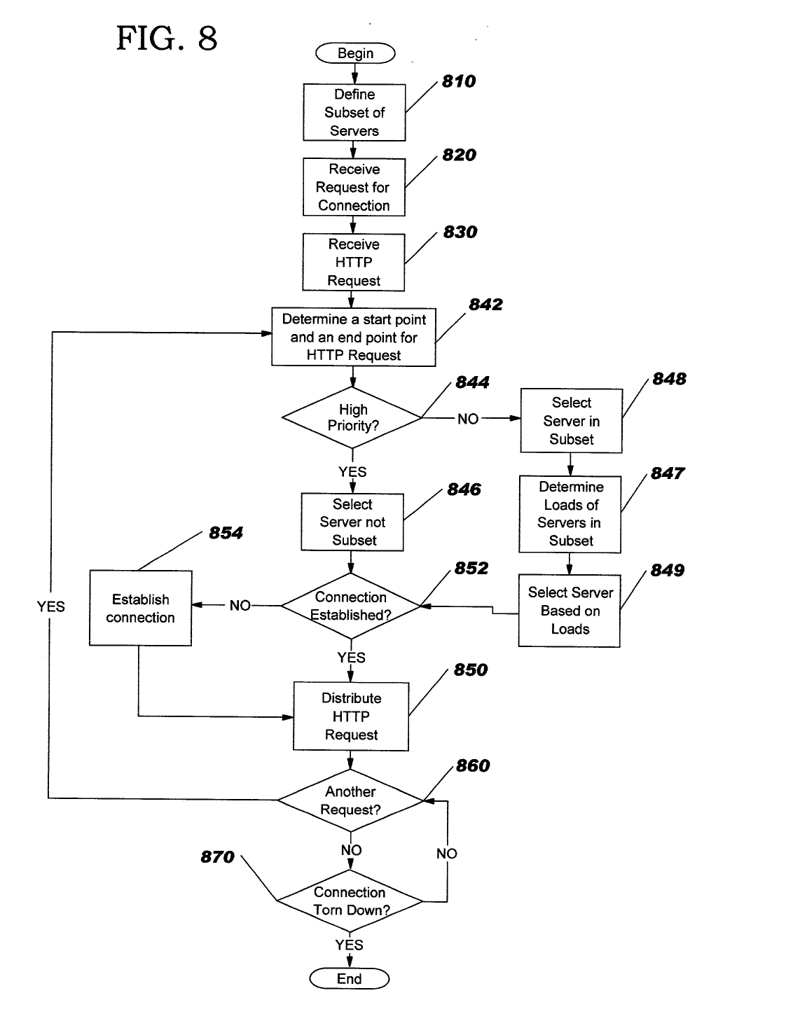

Now referring to FIG. 8, a flowchart illustrating operations carried out by a workload distributor according to still further embodiments of the present invention will be described. A subset of a plurality of servers that are designated to receive HTTP requests having an indication of high priority may be defined (block 810). Each of the plurality of servers may be executing an instance of a requested application. As discussed above, the servers in the subset of servers may have superior operational characteristics which may enable the servers in the subset of servers to provide a relatively higher quality of service (QoS) to a select group of users. These operational characteristics may include content location, processing speed, available memory or other performance criteria, communication capabilities, such as total available bandwidth, connection speed, connection type or the like, security issues or even ownership issues such as ownership and/or control of the data processing systems.

A request for an HTTP 1.1 connection from the network to the workload distributor may be received (block 820) and may be stored in an incoming buffer. An HTTP 1.1 connection is the type of connection that does not close after a single request is processed. Thus, a plurality of HTTP requests may be received over a single HTTP 1.1 connection. An HTTP request for an application is received over the HTTP 1.1 connection (block 830) and may be stored in an incoming buffer. The HTTP request may be, for example, a GET request, a HEAD request, a PUT request, a POST request or the like.

A starting point and ending point for each HTTP request received over the single HTTP 1.1 connection is determined (block 842). This state information may be stored in the incoming buffer. The HTTP request may be parsed to determine if the HTTP request contains any relevant application layer information, such as information available above the TCP/IP layers (e.g. “layer 7” information) (block 844). Relevant application layer information may include a type of request, a client identification, an individual user identification, a cookie or the like. The presence of relevant application layer information may be an indication of high priority. Thus, requests with an indication of high priority may be routed to the subset of reserved servers used to satisfy important requests.

If it is determined that the HTTP request has an indication of high priority (block 844), a server in the subset of servers may be selected as the destination server for the HTTP request (block 848). If the request is determined to have an indication of high priority, the loads of each of the servers in the subset of servers may be determined (block 847). The request may be distributed based on the loads of the servers in the subset of servers (block 849). For example, the request may be distributed to the server in the subset of servers with the lightest load. If it is determined that the HTTP request does not have an indication of high priority (block 844), a server that is not in the subset of servers may be selected as the destination server for the HTTP request (block 848).

It is determined if a connection to the selected server is established (block 852). If the connection is not established, the workload distributor may establish the connection (block 854) and distribute the HTTP request over the newly established connection. If it is determined that the connection is already established (block 852), the request is distributed to the selected server over the previously established connection (block 850).

It will be understood that the workload distributor tracks the distributed requests and corresponding responses. The response may be stored in an outgoing buffer while the workload distributor translates the network address from the addressing scheme of the destination server to the addressing scheme of a network. Once translated, the response may be distributed over the network to a client. As discussed above, routing of the plurality of requests and corresponding responses may be accomplished using network address translation and session control translation at a routing layer of a communication protocol stack or at an application layer.

Returning to FIG. 8, it is determined if another request has been received over the HTTP 1.1 connection (block 860). If another request has been received operations return to block 842 and the process repeats until no more HTTP requests have been received or it is determined that the HTTP 1.1 connection has been torn down (block 870). If it is determined that another request has not been received (block 860), operations remain at block 860 until a request is received or it is determined that the HTTP 1.1 connection has been torn down (block 870). It will be understood by those having skill in the art that the tasks carried out by the workload distributor may be carried out by an application executing on a data processing system.

Embodiments of the present invention have been described with reference to FIGS. 4 through 8 which are block diagrams and flowchart illustrations of operations of protocol stacks incorporating embodiments of the present invention. It will be understood that each block of the flowchart illustrations and/or block diagrams, and combinations of blocks in the flowchart illustrations and/or block diagrams, can be implemented by computer program instructions. These program instructions may be provided to a processor to produce a machine, such that the instructions which execute on the processor create means for implementing the functions specified in the flowchart and/or block diagram block or blocks. The computer program instructions may be executed by a processor to cause a series of operational steps to be performed by the processor to produce a computer implemented process such that the instructions which execute on the processor provide steps for implementing the functions specified in the flowchart and/or block diagram block or blocks.

Accordingly, blocks of the flowchart illustrations and/or block diagrams support combinations of means for performing the specified functions, combinations of steps for performing the specified functions and program instructions for performing the specified functions. It will also be understood that each block of the flowchart illustrations and/or block diagrams, and combinations of blocks in the flowchart illustrations and/or block diagrams, can be implemented by special purpose hardware-based systems which perform the specified functions or steps, or combinations of special purpose hardware and computer instructions.

While the present invention has been described with respect to the workload distribution function as an application, as will be appreciated by those of skill in the art, such functions may be provided as separate functions, objects or applications which may cooperate with a communication protocol stack or may be incorporated into a communication protocol stack. Furthermore, the present invention has been described with reference to particular sequences of operations. However, as will be appreciated by those of skill in the art, other sequences may be utilized while still benefiting from the teachings of the present invention. Thus, while the present invention is described with respect to a particular division of functions or sequences of events, such divisions or sequences are merely illustrative of particular embodiments of the present invention and the present invention should not be construed as limited to such embodiments.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of distributing workload between a plurality of servers, the method comprising:
receiving a plurality of requests over a first connection;
parsing the plurality of requests to determine application layer information associated with each of the plurality of requests;
selecting destination servers for corresponding ones of the plurality of requests based on the determined application layer information associated with each of the plurality of requests; and
distributing the plurality of requests to the corresponding selected destination servers over a plurality of second connections associated with respective ones of the destination servers.

2. A method according to claim 1, wherein the first connection comprises an HTTP 1.1 connection.

3. A method according to claim 1, wherein parsing the plurality of requests comprises:
determining a start point and an end point for each of the plurality of requests within the first connection; and
identifying application layer information within each of the plurality of requests.

4. A method according to claim 3, wherein the application layer information comprises layer 7 information and above.

5. A method according to claim 3, wherein the application layer information comprises at least one of a type of request, a client identification, an individual user identification, and a cookie.

6. A method of claim 1, wherein the plurality of requests comprise a plurality of Hypertext Transport Protocol(HTTP) requests.

7. A method according to claim 1, wherein selecting destination servers for corresponding ones of the plurality of requests comprises:
determining if the determined application layer information associated with each of the plurality of requests is relevant application layer information;
selecting one of a subset of the destination servers if the application layer information associated with each of the plurality of requests is relevant application layer information; and
selecting a destination server other than a destination server in the subset of the destination servers if the application layer information associated with each of the plurality of requests is not relevant application layer information.

8. A method of claim 7, wherein selecting one of a subset of the destination servers if the application layer information associated with each of the plurality of requests is relevant application layer information, further comprises:
determining a load associated with respective destination servers in the subset of destination servers; and
selecting the destination server in the subset of the destination servers based on the determined load.

9. A method of claim 7, wherein the subset of destination servers includes at least one server which is to receive requests having an indication of high priority, and wherein the indication of high priority is determined based on the existence and nonexistence of relevant application layer information.

10. A method according to claim 1, wherein distributing the plurality of requests comprises:
determining if a second connection associated with a selected destination servers exists;
establishing the second connection to the selected destination server if the second connection does not exist;
distributing a request to the selected destination servers over the second connection; and
repeating the determining, establishing and distributing for each of the plurality of requests.

11. A method according to claim 1, wherein receiving, parsing, selecting and distributing are carried out by an application executing on a data processing system.

12. A method according to claim 1, further comprising tracking the plurality of requests and a plurality of corresponding responses to the plurality of requests.

13. A method according to claim 1, wherein distributing the plurality of requests, comprises:
routing the plurality of requests using network address translation at a routing layer of a communication protocol stack.

14. A method according to claim 13, wherein routing the plurality of requests further comprises routing the plurality of requests using session control translation at the routing layer of the communication protocol stack.

15. A method according to claim 14, wherein routing the plurality of requests includes routing the corresponding responses to the plurality of requests using network address translation at a routing layer of a communication protocol stack.

16. A method of distributing workload between a plurality of servers, wherein each of the plurality of servers is executing an instance of an application which communicates over a network such that each of a plurality of HTTP requests within a single HTTP 1.1 connection to the application may be distributed to any one of the plurality of servers, the method comprising:
defining a subset of the plurality of servers which are to receive HTTP requests having an indication of high priority;
establishing an HTTP 1.1 connection responsive to receiving a request for an HTTP 1.1 connection to the application over the network;
receiving a first Hypertext Transport Protocol(HTTP) request within the HTTP 1.1 connection;
parsing the first HTTP request to determine if the first HTTP request has an indication of high priority based on application layer information included in the first HTTP request; and
distributing the first HTTP request to one of the subset of the plurality of servers over a first connection if the first HTTP request has an indication of high priority.

17. A method according to claim 16, further comprising:
distributing the first HTTP request to a server other than a server in the subset of the destination servers if the first HTTP request does not have an indication of high priority.

18. The method according to claim 16, further comprising:
receiving a second HTTP request within the HTTP 1.1 connection
parsing the second HTTP request to determine if the second HTTP request has an indication of high priority based on application layer information included in the second HTTP request;
distributing the second HTTP request to one of the subset of the plurality of servers over a second connection if the second HTTP request has an indication of high priority; and
repeating the receiving, parsing and distributing steps for each subsequent HTTP request received within the HTTP 1.1 connection.

19. A method according to claim 16, wherein distributing the first HTTP request, further comprises:
determining a load associated with respective servers in the subset of the plurality of servers; and
distributing the first HTTP request to the server in the subset of the plurality of servers based on the determined load.

20. A method according to claim 16, wherein the indication of high priority is based on the existence and nonexistence of relevant application layer information.

21. A method according to claim 20, wherein the application layer information comprises at least one of a type of request, a client identification, an individual user identification, and a cookie.

22. A method according to claim 20, wherein the application layer information comprises layer 7 information and above.

23. A method according to claim 16, wherein parsing the first HTTP request comprises:
determining a start point and an end point for the first HTTP request within the HTTP 1.1 connection;
identifying application layer information within the first HTTP request; and
determining if the application layer information is relevant application layer information.

24. A method according to claim 16, wherein distributing the first HTTP request comprises:
determining if a first connection exists;
establishing the first connection if the first connection does not exist; and
distributing the first HTTP request over the first connection.

25. A method according to claim 16, wherein the steps of defining, receiving, parsing, and distributing are carried out by an application executing on a data processing system.

26. A method according to claim 16, further comprising tracking the HTTP request and a corresponding response to the HTTP request.

27. A method according to claim 16, wherein distributing the first HTTP request comprises:
routing the first HTTP request using network address translation at a routing layer at a communication protocol stack.

28. A method according to claim 27, wherein routing the first HTTP request further comprises routing the first HTTP request using session control translation at the routing layer at the communication protocol stack.

29. A method according to claim 28, wherein routing the first HTTP request includes routing the corresponding response to the first HTTP request using network address translation at a routing layer of a communication protocol stack.

30. A system for distributing workload between a plurality of servers, comprising:
means for receiving a plurality of requests over a first connection;
means for parsing the plurality of requests to determine application layer information associated with each of the plurality of requests;
means for selecting destination servers for corresponding ones of the plurality of requests based on the determined application layer information associated with each of the plurality of requests; and
means for distributing the plurality of requests to the corresponding selected destination servers over a plurality of second connections associated with respective ones of the destination servers.

31. A system for distributing workload between a plurality of servers, wherein each of the plurality of servers is executing an instance of an application which communicates over a network such that each of a plurality of HTTP requests within a single HTTP 1.1 connection to the application may be distributed to any one of the plurality of servers, comprising:
means for defining a subset of the plurality of servers which are to receive HTTP requests having an indication of high priority;
means for establishing an HTTP 1.1 connection responsive to receiving a request for an HTTP 1.1 connection to the application over the network;
means for receiving a first Hypertext Transport Protocol(HTTP) request within the HTTP 1.1 connection;
means for parsing the first HTTP request to determine if the first HTTP request has an indication of high priority based on application layer information included in the first HTTP request; and
means for distributing the first HTTP request to one of the subset of the plurality of servers over a first connection if the first HTTP request has an indication of high priority.

32. A computer program product for distributing workload between a plurality of servers, comprising:
a computer readable program medium having computer readable program code embodied therein, the computer readable program code comprising:
computer readable program code which receives a plurality of requests over a first connection;
computer readable program code which parses the plurality of requests to determine application layer information associated with each of the plurality of requests;
computer readable program code which selects destination servers for corresponding ones of the plurality of requests based on the determined application layer information associated with each of the plurality of requests; and
computer readable program code which distributes the plurality of requests to the corresponding selected destination servers over a plurality of second connections associated with respective ones of the destination servers.

33. A computer program product for distributing workload between a plurality of servers, wherein each of the plurality of servers is executing an instance of an application which communicates over a network such that each of a plurality of HTTP requests within a single HTTP 1.1 connection to the application may be distributed to any one of the plurality of servers, comprising:
a computer readable program medium having computer readable program code embodied therein, the computer readable program code comprising:
computer readable program code which defines a subset of the plurality of servers which are to receive HTTP requests having an indication of high priority;
computer readable program code which establishes an HTTP 1.1 connection responsive to receiving a request for an HTTP 1.1 connection to the application over the network;
computer readable program code which receives a first Hypertext Transport Protocol(HTTP) request within the HTTP 1.1 connection;
computer readable program code which parses the first HTTP request to determine if the first HTTP request has an indication of high priority based on application layer information included in the first HTTP request; and
computer readable program code which distributes the first HTTP request to one of the subset of the plurality of servers over a first connection if the first HTTP request has an indication of high priority.
